(19) United States
(12) Patent Application Publication
(10) Pub. No.: US 2025/0095134 A1
(43) Pub. Date: Mar. 20, 2025

(54) METHODS AND SYSTEMS FOR VISUAL INSPECTION OF PRODUCTS

(71) Applicant: Panasonic Intellectual Property Management Co., Ltd., Osaka (JP)

(72) Inventors: Andre IVAN, Singapore (SG); Zong Sheng TANG, Singapore (SG); Ariel BECK, Singapore (SG)

(21) Appl. No.: 18/368,443

(22) Filed: Sep. 14, 2023

(51) Int. Cl. G06T 7/00; G06T 7/12; G06T 7/60; G06V 30/14; G06V 30/148; G06V 30/18; G06V 30/19

(52) U.S. Cl. CPC G06T 7/0008; G06T 7/001; G06T 7/12; G06T 7/60; G06V 30/1448; G06V 30/15; G06V 30/1801; G06V 30/18086; G06V 30/19073; G06V 30/1916; G06T 2200/24; G06T 2207/20076; G06T 2207/20132; G06T 2207/30108

(57) ABSTRACT

The present disclosure discloses a method and system for visual inspection of a target product. The method includes a) receiving an image associated with the target product; generating a plurality of region of interests (ROIs) associated with the image; identifying, based on the plurality of non-terminal ROIs, a first set of features and a second set of features associated with the image. The first set of features and the second set of features are indicative of one of a presence of defect within the image or an absence of defect within the image. The method also includes determining, based on the first set of features and the second set of features, a result of the visual inspection of the target product associated with the image. The result is a success result or a failure result.

### FIELD OF THE INVENTION

The present disclosure relates generally to inspection systems, and more specifically, to methods and systems for visual inspection of a target product and detecting defects near a text area marked on the target product.

### BACKGROUND

Usually, an imaging device is used to capture images of a product for visual inspection and to detect any defects in the product. The product generally comprises a text area having text printed or embossed on the product. The text on the product may be in the form of an alignment of characters, which includes letters, numbers, or symbols. The text area comprises various characters which are combined in a unique manner to provide meta information about the product.

Usually, the text area covers a significant portion of the product's surface which increases the risk that defects or imperfections might be present near or within the text area. In order to detect defects and/or imperfections, text detection techniques may be used. Conventional techniques rely on possible combinations of characters to learn patterns associated with the characters that may be present in the text. Conventional techniques may rely on Machine Learning (ML)/Artificial Intelligence (AI) models to learn the patterns.

However, with conventional techniques, the task of creating a dataset of a vast number of possible combinations of characters that may be present within the text area, and further, training the ML/AI models to learn the matters is computationally difficult. This is because of the operational and computational challenge in training the ML/AI models to learn each pattern individually and accurately identify the characters in the text area. The conventional techniques are thus tedious, slow, computationally heavy, and expensive. Furthermore, conventional technologies are inefficient to provide better visual inspection of the text area of the target product to identify defects therein.

Therefore, there is a need for a solution to address the aforementioned issues and challenges.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an embodiment of the present disclosure, a method for visual inspection of a target product is disclosed. The method includes receiving an image associated with the target product. The method further includes generating a plurality of region of interests (ROIs) associated with the image. The plurality of ROIs includes a plurality of terminal ROIs and a plurality of non-terminal ROIs. The method further includes identifying, based on the plurality of non-terminal ROIs, a first set of features and a second set of features associated with the image. The first set of features and the second set of features are indicative of one of a presence of defect within the image or an absence of defect within the image. The method also includes determining, based on the first set of features and the second set of features, a result of the visual inspection of the target product associated with the image. The result is one of a success result or a failure result.

According to an embodiment of the present disclosure, a method for extracting features from an image associated with a target product is disclosed. The method includes receiving the image associated with the target product. The method further includes identifying at least one pixel blob within the image. The method also includes associating the at least one pixel blob with one of a character or a defect. The method further includes generating a processed image based on the association. Generating the processed image further includes, when the at least one pixel blob is associated with the character: a) removing, from the image, the character to form a respective space within the image; b) determining a mean pixel value associated with the image; and c) filling the respective space within the image with one or more new pixels having the mean pixel value. Generating the processed image further includes retaining the defect within the image when the at least one pixel blob is associated with the defect. The method further includes extracting one or more features from the processed image based on a Histogram of Gradient (HOG) extracting technique.

According to an embodiment of the present disclosure, a system for visual inspection of a target product is disclosed. The system includes a memory and at least one processor communicably coupled with the memory. The at least one processor is configured to receive an image associated with the target product. The at least one processor is also configured to generate a plurality of region of interests (ROIs) associated with the image. The plurality of ROIs comprises a plurality of terminal ROIs and a plurality of non-terminal ROIs. The at least one processor is further configured to identify, based on the plurality of non-terminal ROIs, a first set of features and a second set of features associated with the image. The first set of features and the second set of features are indicative of one of a presence of defect within the image or an absence of defect within the image. The at least one processor is also configured to determine, based on the first set of features and the second set of features, a result of the visual inspection of the target product associated with the image. The result is one of a success result or a failure result.

According to an embodiment of the present disclosure, a system to extract features from an image associated with a target product is disclosed. The system includes a memory and at least one processor communicably coupled with the memory. The at least one processor is configured to receive the image associated with the target product. The at least one processor is further configured to identify at least one pixel blob within the image. The at least one processor is further configured to associate the at least one pixel blob with one of a character or a defect. The at least one processor is configured to generate a processed image based on said association. To generate the processed image, the at least one processor is configured to, when the at least one blob is associated with the character, remove, from the image, the character to form a respective space within the image, determine a mean pixel value associated with the image, and fill the respective space within the image with one or more new pixels having the mean pixel value. To generate the processed image, the at least one processor is configured to, when the at least one blob is associated with the defect, retain the defect within the image. The at least one processor is further configured to extract one or more features from the processed image based on a Histogram of Gradient (HOG) extracting technique.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an environment comprising a system for visual inspection of a target product, according to an embodiment of the present disclosure;

FIG. 2 illustrates an exemplary process flow for visual inspection of the target product, according to an embodiment of the present disclosure;

FIG. 3 illustrates a process flow associated with identifying the second set of features from an image associated with the target product, according to an embodiment of the present disclosure;

FIG. 4A illustrates a flowchart depicting a method for visual inspection of the target product, according to another embodiment of the present disclosure;

FIG. 4B illustrates a flowchart depicting a method for determining the result of the visual inspection of the target product, according to another embodiment of the present disclosure;

FIG. 5A illustrates a flowchart depicting a method for extracting features from the image associated with the target product, according to another embodiment of the present disclosure;

FIG. 5B illustrates a flowchart depicting a method for identifying the at least one pixel blob for each bounding box, according to another embodiment of the present disclosure;

FIG. 5C illustrates a flowchart depicting a method for associating the at least one pixel blob with one of the character or the defect within each bounding box, according to another embodiment of the present disclosure; and

FIGS. 5D-5E illustrate a flowchart depicting a method for detecting remaining defect and removing remaining characters from the image associated with the target product, according to another embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure proposes methods and systems for visual inspection of a target product. The methods and systems identify defects in a text area within an image corresponding to the target product. The methods and systems determine whether a character present in the text area is a defect or a character. The methods and systems remove characters present in the text area leaving only the defects on the image. Further, methods and systems extract and process features from the image to provide a result of visual inspection of the target product.

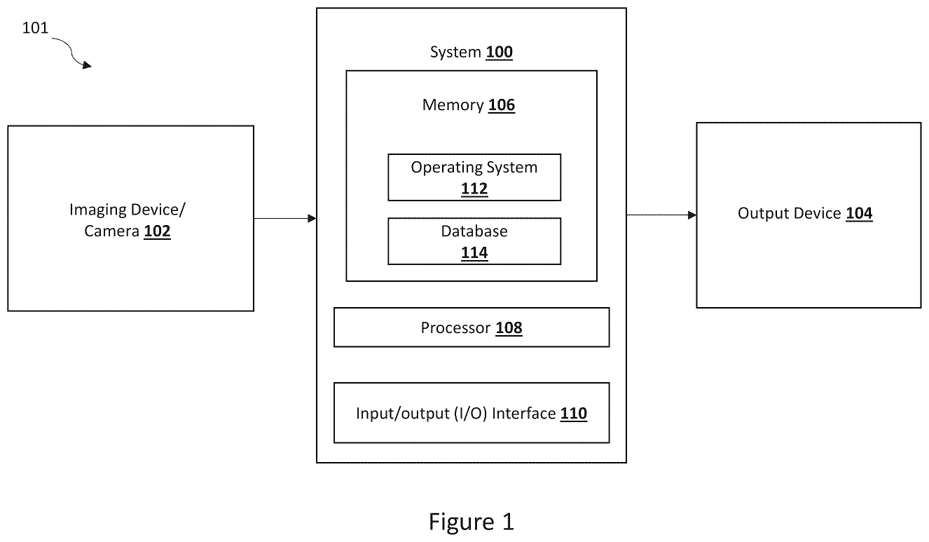

FIG. 1 illustrates an environment 101 comprising a system 100 for visual inspection of a target product, according to an embodiment of the present disclosure.

The environment 101 may further comprise an imaging device/a camera 102 and an output device 104 communicatively coupled to the system 100. The terms ‘imaging device’ and ‘camera’ may be used interchangeably in the present disclosure. The system 100 may be configured to conduct a visual inspection of the target product. The system 100 may be integrated within a server, a personal computing device, a user equipment, a laptop, a tablet, a mobile communication device, and so forth.

In an embodiment, the system 100 may correspond to a stand-alone system provided on an electronic device. The electronic device may include a personal computing device, a user equipment, a laptop, a tablet, a mobile communication device, or any other device capable of hosting processing and memory units. In an embodiment, the imaging device 102 and/or the output device 104 may be integrated with the electronic device hosting the system 100. In an alternate embodiment, the imaging device 102 and/or the output device 104 may be separate devices from the electronic device hosting the system 100.

In another embodiment, the system 100 may be based in a server/cloud architecture and the system 100 may be communicably coupled to the imaging device 102 and the output device 104 via a network (not shown). The network may be a communication network, a wireless network, a wired network, and the like. In another embodiment, the system 100 may be provided in a distributed manner, in that, one or more components of the system 100 may be provided in that, one or more components and/or functionalities of the system 100 are provided through an electronic device, and one or more components and/or functionalities of the system 100 are provided through a cloud-based unit, such as, a cloud storage or a cloud-based server.

In non-limiting examples, the output device 104 may include, but are not limited to, a display unit, an indicating device, a recording device, a computing device, and so forth. In an embodiment, the output device 104 may be associated with a graphical user interface, an interactive user interface, and the like.

The system 100 may include a memory 106, at least one processor 108, and an Input/Output (I/O) interface 110. In an exemplary embodiment, the at least one processor 108 may be operatively coupled to the I/O interface 110 and the memory 106.

In one embodiment, the at least one processor 108 may be operatively coupled to the memory 106 for processing, executing, or performing a set of operations. The at least one processor 108 may include at least one data processor for executing processes in Virtual Storage Area Network. In another embodiment, the at least one processor 108 may include specialized processing units such as, integrated system (bus) controllers, memory management control units, floating point units, graphics processing units, digital signal processing units, etc. In one embodiment, the processor 108 may include a Central Processing Unit (CPU), a Graphics Processing Unit (GPU), or both. In another embodiment, the at least one processor 108 may be one or more general processors, digital signal processors, application-specific integrated circuits, field-programmable gate arrays, servers, networks, digital circuits, analog circuits, combinations thereof, or other now-known or later developed devices for analyzing and processing data. The at least one processor 108 may execute a software program, such as code generated manually (i.e., programmed) to perform one or more operations disclosed in the present disclosure.

The at least one processor 108 may be disposed in communication with one or more input/output (I/O) devices, such as imaging device 102 and output device 104, via the I/O interface 110. The I/O interface 110 may employ communication code-division multiple access (CDMA), high-speed packet access (HSPA+), global system for mobile communications (GSM), long-term evolution (LTE), WiMax, or the like, etc.

In an embodiment, the at least one processor 108 may be disposed in communication with a communication network via a network interface. In an embodiment, the network interface may be the I/O interface 110. The network interface may connect to the communication network to enable connection of the system 100 with the outside environment and/or device/system. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 100 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

Furthermore, the memory 106 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory 106 is communicatively coupled with the processor 108 to store bitstreams or processing instructions for completing the process. Further, the memory 106 may include an operating system 112 for performing one or more tasks of the system 100, as performed by a generic operating system in the communications domain or the standalone device. In an embodiment, the memory 106 may comprise a database 114 configured to store the information as required by the processor 108 to perform one or more functions for visual inspection of a target product, as discussed throughout the disclosure.

The memory 106 may be operable to store instructions executable by the processor 108. The functions, acts, or tasks illustrated in the figures or described may be performed by the processor 108 for executing the instructions stored in the memory 106. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

For the sake of brevity, the architecture and standard operations of the memory 106 and the processor 108 are not discussed in detail. In one embodiment, the memory 106 may be configured to store the information as required by the processor 108 to perform the methods described herein.

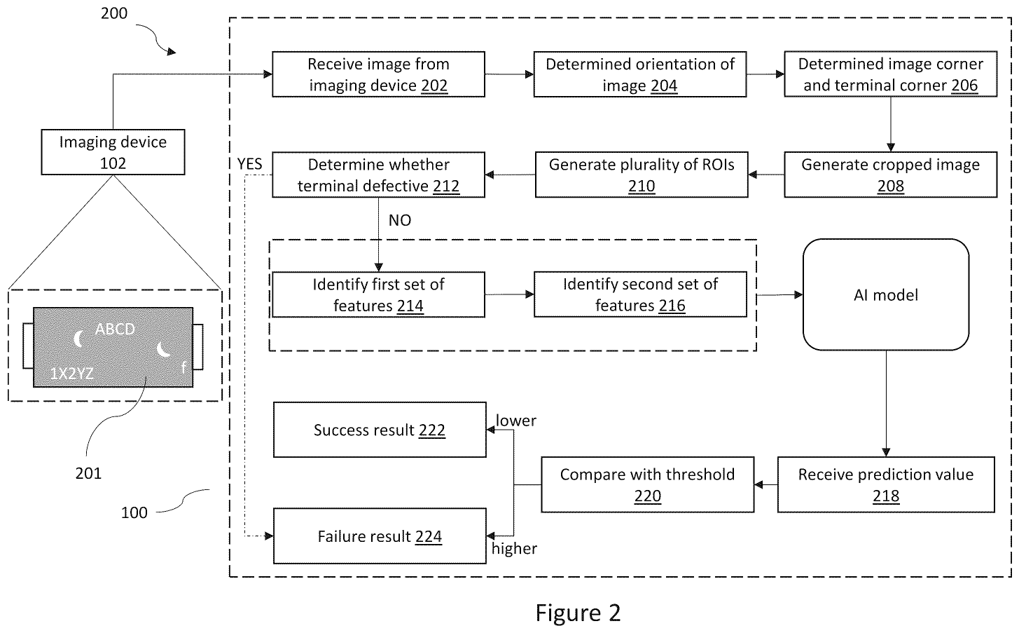

FIG. 2 illustrates a process flow 200 for visual inspection of a target product, in accordance with an embodiment of the present disclosure. Referring to FIGS. 1 and 2 collectively, the imaging device 102 may capture an image of a product 201 (hereinafter referred to as ‘target product’) and send the image to the system 100.

In an embodiment, the system 100 may be configured to receive an image associated with the target product, as shown by block 202. In an embodiment, the target product may include a product having text and/or defects thereon. In an embodiment, the target product may be a capacitor. The image may be captured by the imaging device 102 and sent to the at least one processor 108. In an embodiment, the image may be captured by the imaging device 102 in real-time. The image may comprise a text area comprising information such as marked texts, serial numbers, bar codes, alphanumeric codes or data matrix codes corresponding to the target product, and other product related information. The system 100 may process the received image through at least one processor 108 to generate an output indicative of the result of the visual inspection of the target product, as will be described in detail further below. The output may be displayed on the output device 104.

The at least one processor 108 may be configured to determine an orientation associated with the received image based on an edge filtering technique, as shown by block 204. The target product may be in various positions and orientations physically, hence, the alignment of the image of the target product may be performed by the at least one processor 108 to facilitate efficient visual inspection. In an embodiment, the edge filtering technique may be associated with a Sobel filter. To determine the orientation, the at least one processor 108 may be configured to process the image to determine continuous lines using a line detection algorithm. The at least one processor 108 may be configured to determine two continuous, long lines indicative of orientation of the target product. The at least one processor 108 may further be configured to compute an angle of the determined continuous lines with respect to a reference horizontal line, the angle being indicative of the orientation of the image with respect to the reference horizontal line. The at least one processor 108 may further be configured to rotate the image based on the determined orientation.

Further, the at least one processor 108 may be configured to determine at least one image corner and at least one terminal corner associated with the received image based on the edge filtering technique, as shown by block 206. The target product may be associated with a set of terminals and a central portion comprising the text area. The at least one image corner may be associated with corners of the central portion while the at least one terminal corner may be associated with the corners of each of the set of terminals. In an embodiment, to determine the at least one image corner, a first and last corner of the central portion of the target product within the image may be determined over a set of axes, such as ‘x’ and ‘y’ axis of a graphical representation. Based on the first and last corners, the at least one image corner may be determined. In an embodiment, to determine the at least one terminal corner, the image with the at least one image corner determined may be cropped based on the at least one image corner, and a first and last corner of the set of terminals of the target product within the image may be determined over the set of axes. Based on the first and last corners, the at least one terminal corner may be determined

The at least one processor 108 may be configured to generate a cropped image based on determined orientation, the determined at least one image corner and the determined at least one terminal corner, as shown by block 208. Accordingly, an accurate image of the target product in obtained in proper orientation to facilitate visual inspection of the target product.

Further, the at least one processor 108 may be configured to generate a plurality of region of interests (ROIs) based on the cropped image, as shown by block 210. The plurality of ROIs may comprise a plurality of terminal ROIs and a plurality of non-terminal ROIs. The plurality of terminal ROIs may be associated with the set of terminals of the target product within the image while the plurality of non-terminal ROIs may be associated with the central portion of the target product within the image. Each of the plurality of ROIs may refer to objects of interest present in a virtual boundary, which may be a part of the image or the whole image. Each of the plurality of ROIs may be defined by predetermined parameters, such as, size, orientation, width, height, etc, of the corresponding ROI within the image. In a non-limiting example, the plurality of ROIs may be eleven, in which, the plurality of terminal ROIs may be two and the plurality of non-terminal ROIs may be nine.

The processor 108 may be configured to identify, based on the plurality of non-terminal ROIs, a first set of features and a second set of features associated with the image, as shown by blocks 214 and 216 respectively. The first set of features and the second set of features are indicative of a presence of defect within the image or an absence of defect within the image.

Furthermore, the at least one processor 108 may be configured to determine whether at least one terminal of the set of terminals of the target product is associated with a defective length, based on the at least one terminal corner, as shown by block 212. In an embodiment, the at least one terminal corner may be compared with a predetermined length threshold, and a defect in the length of one or both terminals of the set of terminals may be determined. Upon determining that the terminal of the target product is not associated with the defective length, the at least one processor 108 may identify the first set of features and the second set of features associated with the image at blocks 214 and 216 respectively. Upon determining that the terminal of the target product is not associated with the defective length, the at least one processor 108 may be configured to determine a result of the visual inspection to be a failure result.

To identify the first set of features, the at least one processor 108 may be configured to extract one or more statistical features from each non-terminal ROI of the plurality of non-terminal ROIs. The one or more statistical features may include average, standard deviation, median, skewness, and kurtosis corresponding to each non-terminal ROI. The at least one processor 108 may further be configured to generate the first set of features based on the extracted one or more statistical features from each non-terminal ROI of the plurality of non-terminal ROIs. As a non-limiting example, considering nine non-terminal ROIs, five statistical features (average, standard deviation, median, skewness, and kurtosis) for each of the nine non-terminal ROIs may be extracted. The first set of features may thus be defined by 5*9=45 statistical features corresponding to the image.

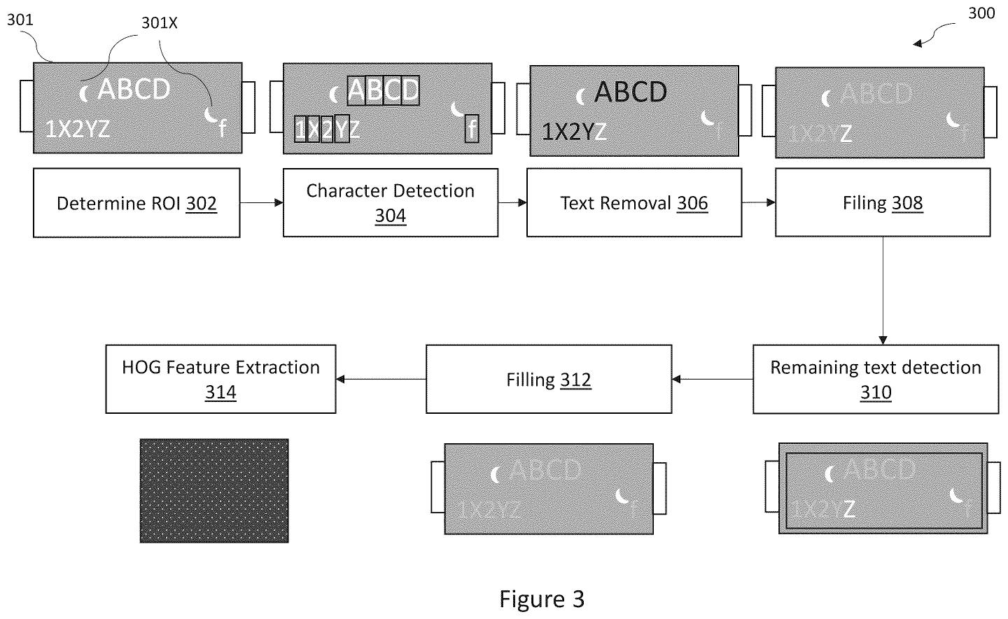

The at least one processor 108 may be configured to identify the second set of features, as shown by block 216. FIG. 3 illustrates a process flow 300 associated with identifying the second set of features from an image 301 associated with the target product. The image may comprise defects 301X. Referring collectively to FIGS. 1-3, to identify the second set of features, the at least one processor 108 may be configured to determine a first ROI from among the plurality of ROIs within the image, as shown by block 302. The first ROI may be indicative of the text area within the image, i.e., an area of the image comprising text in the form of one or more characters. The at least one processor 108 may be configured to detect the one or more characters within the first ROI based on a character detection technique.

For each detected character, the at least one processor 108 may be configured to generate a bounding box associated with a corresponding character of the one or more characters, as shown by block 304. Accordingly, the at least one processor 108 may be configured to generate one or more bounding boxes within the image. In an embodiment, each of the one or more bounding boxes may include a plurality of pixels associated with a pixel value.

The at least one processor 108 may be configured to perform a text removal process for each bounding box of the one or more bounding boxes, in order to generate a processed image, as shown by block 306. It is appreciated that one or more details of the text removal process may be described with reference to a bounding box, and the details are equally applicable for each of the one or more bounding boxes.

In the text removal process, for each bounding box, the at least one processor 108 may be configured to identify at least one pixel blob based on the plurality of pixels in the bounding box. The at least one processor 108 may determine a pixel value associated with each pixel of the plurality of pixels within the bounding box. In one example, the pixel value may vary in a range from 0 (black) to 255 (white).

The at least one processor 108 may be configured to compare the pixel value with a pixel value threshold. The pixel value threshold may be determined based on a flash intensity and a lighting intensity used when the image is captured by the imaging device 102. The pixel value threshold may further be determined based on a colour of the text (characters) printed on the target product. In a non-limiting example, if the colour ‘white’ is used for printing the characters on the target product, the pixel value threshold may be a value close to 255 (corresponding to white colour). In an embodiment, the pixel value threshold may be stored in the database 114 of the memory 106.

The at least one processor 108 may be configured to identify at least one first set of pixels from the plurality of pixels based on the comparison of the pixel value of each of the plurality of pixels with the pixel value threshold. Each pixel of the first set of pixels has a pixel value greater than the pixel value threshold. The at least one processor 108 may be configured to determine the at least one first set of pixels as the at least one pixel blob within the bounding box.

Further in the text removal process, for each bounding box, the at least one processor 108 may be configured to associate the at least one pixel blob with one of the characters within the bounding box or a defect within the bounding box. That is, the at least one processor 108 may be configured to determine whether the text within the bounding box is a character or a defect.

The at least one processor 108 may be configured to determine a size of the at least one pixel blob within the bounding box based on a number of the at least one first set of pixels associated with the at least one pixel blob. That is, a count of the at least one first set of pixels may be determined, in that, the at least one first set of pixels are connected to each other in horizontal, vertical, and diagonal direction, thereby forming the at least one pixel blob. The size of the at least one pixel blob may refer to the count of the connected at least one first set of pixels.

The at least one processor 108 may be configured to determine whether the size of the at least one pixel blob is within a first threshold range. In an embodiment, the first threshold range may be determined based on predetermined character combinations to be printed on the target product and predetermined smallest and biggest characters to be printed on the target product. The first threshold range may thus define upper and lower limits for the at least one blob to be considered as a character. In an embodiment, the first threshold range may be stored in the database 114 of the memory 106. If the size of the at least one pixel blob is within the first threshold range, the at least one processor 108 may associate the at least one pixel blob with the character within the bounding box. If the size of the at least one pixel blob is not within the first threshold range, the at least one processor 108 may associate the at least one pixel blob with a defect within the bounding box.

Accordingly, the at least one processor 108 is configured to determine, for each bounding box of the one or more bounding boxes, whether the corresponding character within the bounding box is only a character or is additionally associated with a defect as well.

Further in the text removal process, the at least one processor 108 may be configured to generate a processed image based on the association of the at least one pixel blob of each bounding box of the one or more bounding boxes. When the at least one processor 108 associates the at least one pixel blob with the character within the bounding box, the at least one processor 108 may be configured to retain the defect within the image.

As shown in block 306, when the at least one processor 108 associates the at least one pixel blob with the character within the bounding box, the at least one processor 108 may be configured to remove the character to form a respective space within the image. Further, the at least one processor 108 may be configured to determine a mean pixel value associated with the image and fill the respective space within the image with one or more new pixels having the mean pixel value, as shown by block 308.

Accordingly, the processed image may be generated which comprises characters removed and filled with new pixels while the defects are not removed, rather, defects are retained. As seen in the image 301 associated with block 308, the text “ABCD”, “1X2Y”, and ‘f’ is removed while the defects 301X are retained.

In an embodiment, the at least one processor 108 may further be configured to repeat the text removal process on the processed image, as shown by block 310. As seen in the image 301 associated with block 308, the character “Z” is missed in character detection and hence not removed. In the repeated text removal process, the at least one processor may be configured to identify one or more additional pixel blobs based on one or more second set of pixels within the processed image. Each pixel of the one or more second set of pixels may have a corresponding pixel value greater than the pixel value threshold. To identify the one or more additional pixel blobs, the at least one processor 108 may be configured to take into account the first ROI collectively, rather than each of the one or more bounding boxes separately.

The at least one processor 108 may further be configured to determine a corresponding size of the one or more additional pixel blobs within the processed image and determine whether the corresponding size of the one or more additional pixel blobs is within a second threshold range. In an embodiment, the second threshold range may be associated with a smaller range as compared to the first threshold range. That is, the first threshold range may comprise a first lower threshold and a first upper threshold while the second threshold range may comprise a second lower threshold and a second upper threshold. The first upper threshold may be greater than the second upper threshold and the first lower threshold may be lower than the second lower threshold. In an embodiment, the second threshold range may be stored in the database 114 of the memory 106.

If the corresponding size of the one or more additional pixel blobs is within the second threshold range, the at least one processor 108 may be configured to associate the one or more additional pixel blobs with a corresponding remaining character within the processed image. If the corresponding size of the one or more additional pixel blobs is not within the second threshold range, the at least one processor 108 may be configured to associate the one or more additional pixel blobs with a corresponding remaining defect within the processed image.

When the one or more additional pixel blobs are associated with the corresponding remaining character within the processed image, the at least one processor 108 may further be configured to remove the corresponding remaining character from the processed image to form a respective space within the processed image. The at least one processor 108 may be configured to fill the respective space within the processed image with the mean pixel value, as shown by block 312. When the one or more additional pixel blobs are associated with the corresponding remaining defect, the at least one processor 108 may retain the corresponding remaining defect within the processed image. Accordingly, with the repeated text removal process, the processed image may be refined to remove any remaining characters while retained any remaining defects. As seen in the image associated with block 312, the remaining character “Z” is removed while the defects 301X are retained.

Further, the at least one processor 108 may be configured to extract the second set of features from the processed image based on a Histogram of Gradient (HOG) extracting technique, as shown by block 314. The second set of features may thus be identified from the image.

Referring to FIGS. 1-2, the at least one processor 108 may be configured to determine a result of the visual inspection of the target product associated with the image based on the first set of features and the second set of features. The result of the visual inspection may be one of a success result or a failure result. In an embodiment, the at least one processor 108 may be configured to determine the result of the visual inspection of the target product based on a trained artificial intelligence (AI) model. In an embodiment, the trained AI model may be a trained mathematical model. In an embodiment, the AI model may be stored in the database 114 of the memory 106.

The at least one processor 108 may be configured to provide the first set of features and the second set of features as an input to the AI model. The at least one processor 108 may be configured to receive a prediction value indicative of a probability of the presence of defect within the image or a probability of the absence of defect within the image from the AI model, as shown by block 218. In an embodiment, the prediction value may be a numerical value between 0 and 1.

The at least one processor 108 may be configured to compare the prediction value with a predetermined threshold, as shown by block 220. In an embodiment, the predetermined threshold may be stored in the database 114 of the memory 106. The at least one processor 108 may determine the result of the visual inspection to be either the success result or the failure result based on the comparison of the prediction value with a predetermined threshold. In an embodiment, the predetermined threshold may be a numerical value between 0 and 1. In an embodiment, the result of the visual inspection may be determined as the success result upon determining that the prediction value is less than the predetermined threshold, as shown by block 222. In an embodiment, the result of the visual inspection may be determined as the failure result upon determining that the prediction value is greater than the predetermined threshold, as shown by block 224.

The at least one processor 108 may further be configured to store the result of the visual inspection of the target product in the database 114 of the memory 106. The at least one processor 108 may be configured to display the result of the visual inspection of the target product on a user interface, such as, the output device 104. Accordingly, a user may view the result of the visual inspection of the target product. In an embodiment, the at least one processor 108 may cause an action to be performed upon determining the result to be the failure result. For instance, the target product may be placed on a conveyor belt and upon determining the result of visual inspection to be the failure result, the target product may be removed from the conveyor belt. Further, it is appreciated that the above-mentioned details may be repeated for multiple target products which are to be visually inspected.

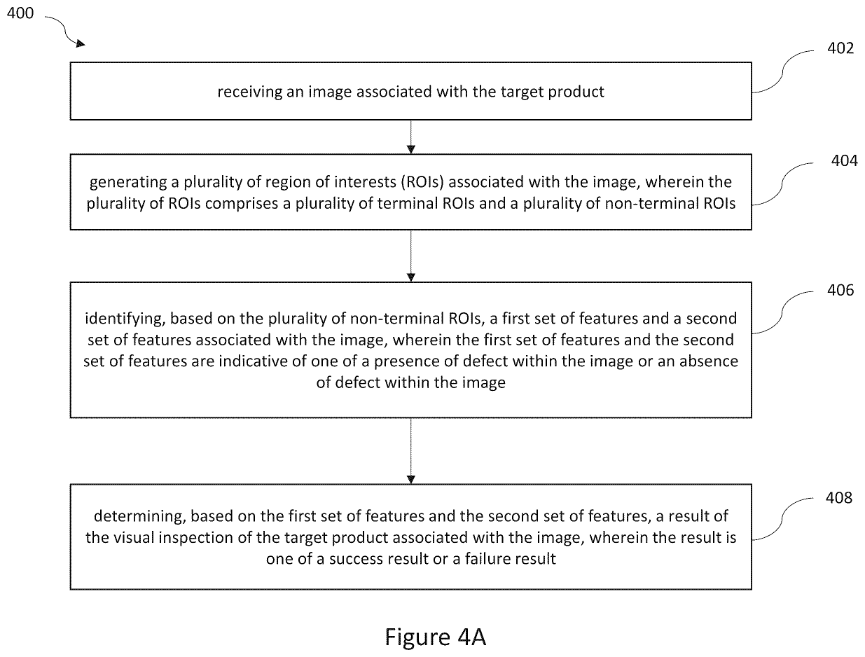

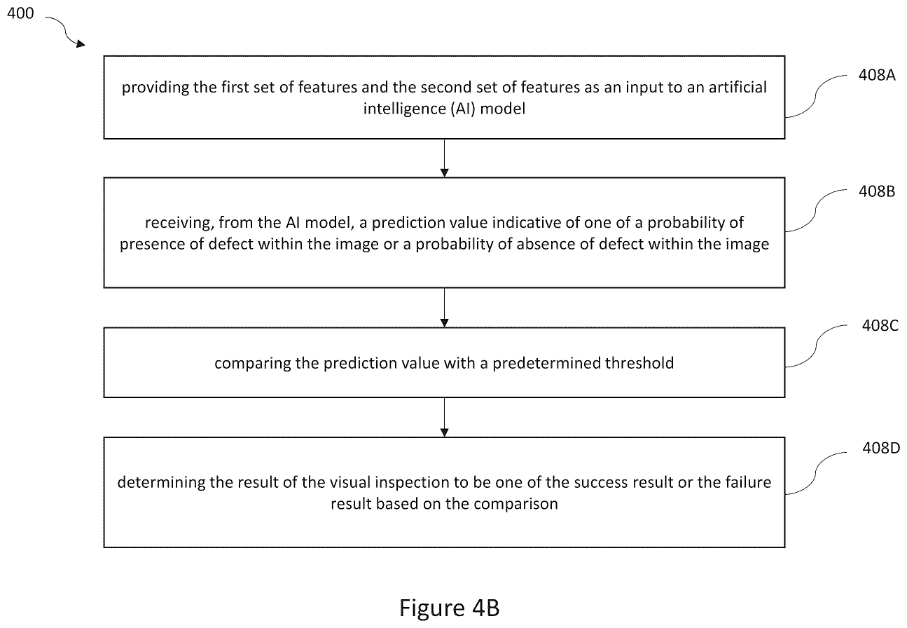

FIG. 4A illustrates a flowchart depicting a method 400 for visual inspection of the target product, according to another embodiment of the present disclosure. The method 400 may be performed by the system 100, in particular, the processor 108 of the system 100.

At step 402, the method 400 includes receiving the image associated with the target product.

At step 404, the method 400 also includes generating the plurality of ROIs associated with the image. The plurality of ROIs includes the plurality of terminal ROIs and the plurality of non-terminal ROIs. In an embodiment, in generating the plurality of ROIs, the method comprises determining an orientation associated with the received image based on an edge filtering technique, determining at least one image corner and at least one terminal corner associated with the received image based on the edge filtering technique, generating a cropped image based on determined orientation, the determined at least one image corner and the determined at least one terminal corner, and generating the plurality of ROIs based on the cropped image.

At step 406, the method 400 further includes identifying, based on the plurality of non-terminal ROIs, the first set of features and the second set of features associated with the image. The first set of features and the second set of features are indicative of either the presence of defect within the image or the absence of defect within the image.

In an embodiment, in identifying the first set of features, the method comprises extracting, from each non-terminal ROI of the plurality of non-terminal ROIs, one or more statistical features. The method further comprises generating the first set of features based on the extracted one or more statistical features from each non-terminal ROI of the plurality of non-terminal ROIs.

In an embodiment, prior to identifying the first set of features and the second set of features, the method comprises determining, based on the at least one terminal corner, whether a terminal of the target product is associated with a defective length. The method further comprises, upon determining that the terminal of the target product is not associated with the defective length, identifying the first set of features and the second set of features associated with the image. The method further comprises, upon determining that the terminal of the target product is associated with the defective length, determining the result of the visual inspection to be a failure result.

At step 408, the method 400 also includes determining, based on the first set of features and the second set of features, the result of the visual inspection of the target product associated with the image. The result is either the success result or the failure result.

In an embodiment, to determine the result of the visual inspection of the target product, the method 400 comprises sub-steps 408A-408D, as depicted in FIG. 4B. At sub-step 408A, the method 400 comprises providing the first set of features and the second set of features as an input to an artificial intelligence (AI) model. At sub-step 408B, the method 400 comprises receiving, from the AI model, a prediction value indicative of one of a probability of presence of defect within the image or a probability of absence of defect within the image. At sub-step 408C, the method 400 comprises comparing the prediction value with a predetermined threshold. At sub-step 408D, the method 400 comprises determining the result of the visual inspection to be one of the success result or the failure result based on the comparison.

In an embodiment, the method 400 further comprises storing the result of the visual inspection of the target product in the database 114. In an embodiment, the method 400 further comprises displaying the result of the visual inspection of the target product on a user interface.

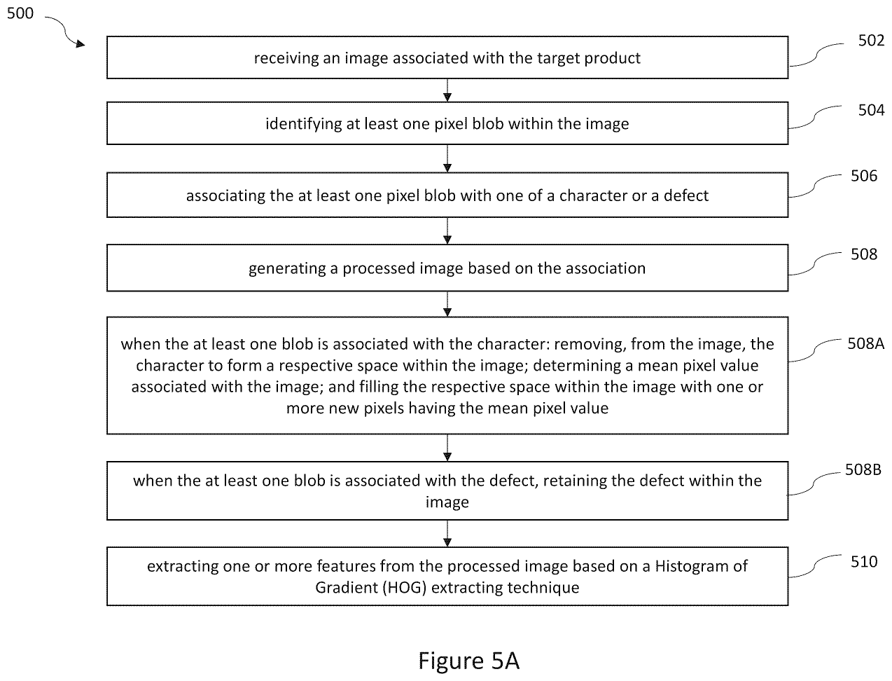

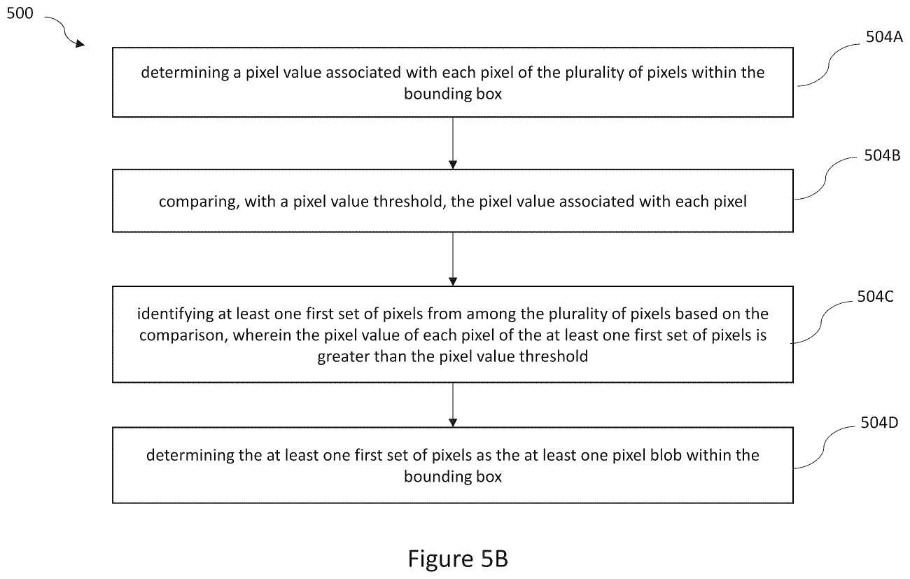

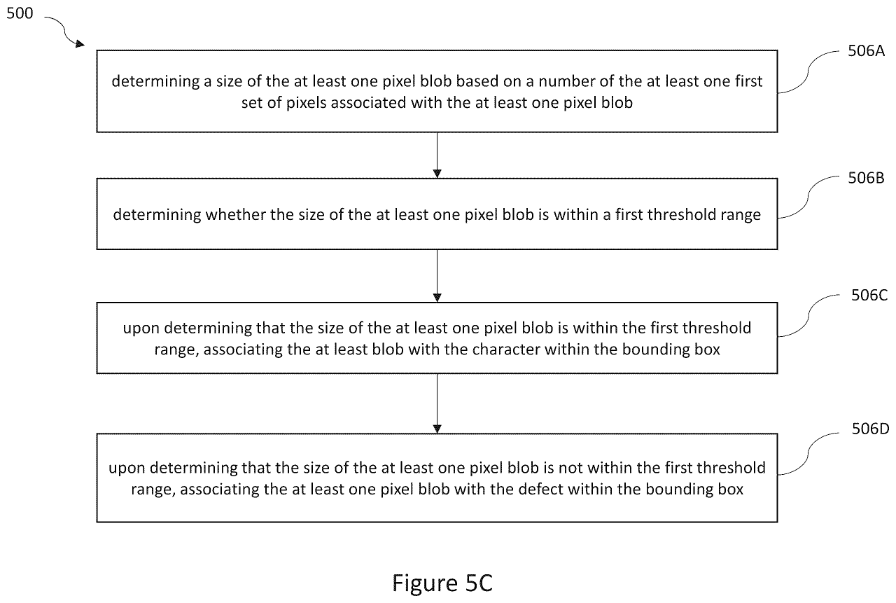

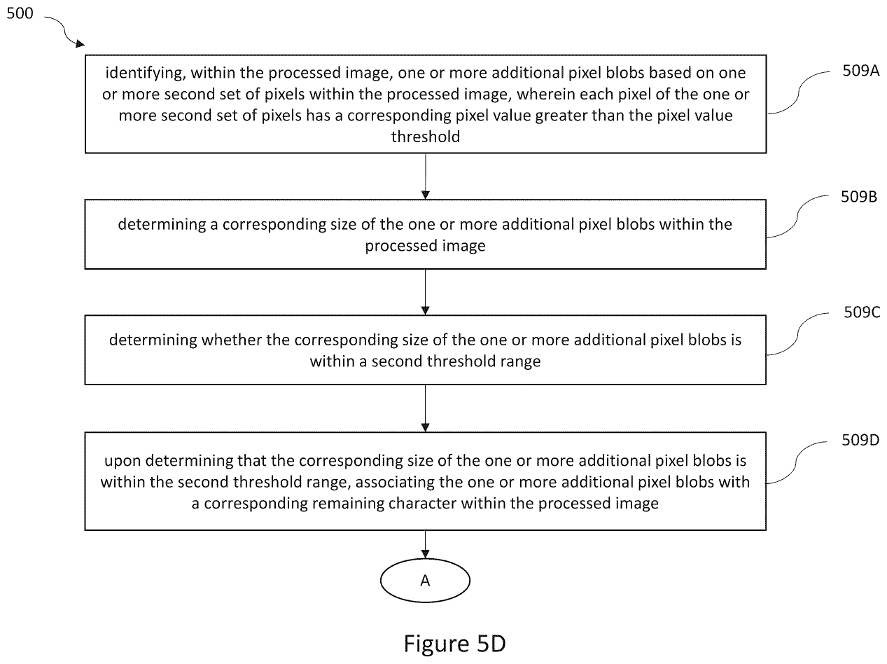

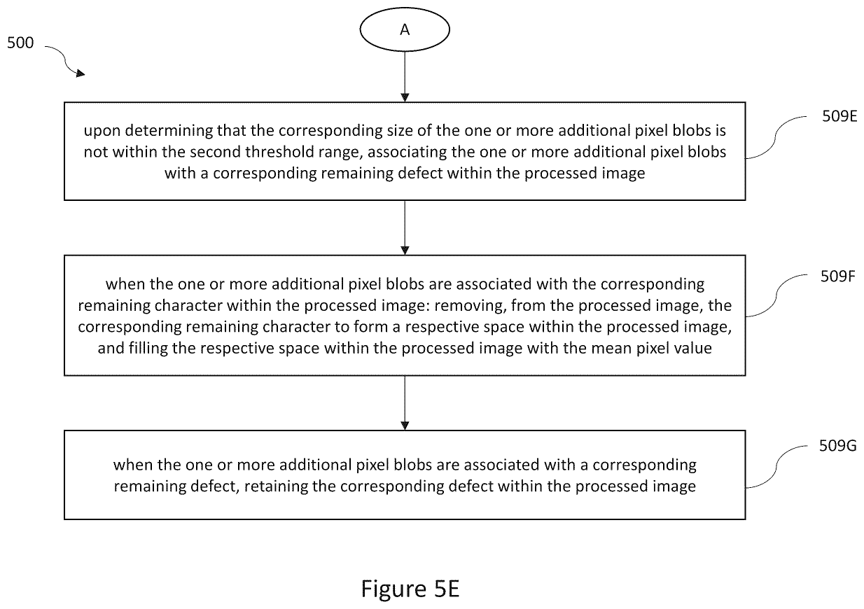

FIG. 5A illustrates a flowchart depicting a method 500 for extracting features from the image associated with the target product, according to another embodiment of the present disclosure. The method 500 may be performed by the system 100, in particular, the processor 108 of the system 100. In an embodiment, the method 500 may correspond to identifying the second set of features, as mentioned in step 406 of FIG. 4A.

At step 502, the method 500 includes receiving the image associated with the target product.

At step 504, the method 500 further includes identifying at least one pixel blob within the image. At step 506, the method 500 includes associating the at least one pixel blob with either a character or a defect. In an embodiment, the method 500 may further comprise determining a ROI within the image, the ROI being indicative of an area of the image comprising one or more characters. The method 500 may further comprise detecting the one or more characters within the ROI based on a character detection technique. The method 500 may further comprise generating one or more bounding boxes by generating a bounding box associated with a corresponding character of the one or more characters.

In an embodiment, in identifying at least one pixel blob within the image, the method 500 comprises identifying, for each bounding box, the at least one pixel blob. In an embodiment, in associating the at least one pixel blob with one of a character or a defect, the method 500 comprises associating, for each bounding box, the at least one pixel blob with one of the character or the defect within the bounding box.

At step 508, the method 500 further includes generating a processed image based on the association. The steps 508 further includes sub-step 508A when the at least one blob is associated with the character and sub-step 508B when the at least one blob is associated with the defect. At sub-step 508A, the method 500 includes removing, from the image, the character to form a respective space within the image, determining the mean pixel value associated with the image, and filling the respective space within the image with the one or more new pixels having the mean pixel value. At sub-step 508B, the method 500 includes retaining the defect within the image.

At step 510, the method 500 includes extracting one or more features from the processed image based on the Histogram of Gradient (HOG) extracting technique. In an embodiment, the extracted one or features correspond to the second set of features in step 406 of FIG. 4A.

In an embodiment, to identify the at least one pixel blob for each bounding box, the method 500 comprises sub-steps 504A-504D for each bounding box, as depicted in FIG. 5B.

At sub-step 504A, the method 500 comprises determining a pixel value associated with each pixel of the plurality of pixels within the bounding box. At sub-step 504B, the method 500 comprises comparing, with a pixel value threshold, the pixel value associated with each pixel. At sub-step 504C, the method 500 comprises identifying at least one first set of pixels from among the plurality of pixels based on the comparison, wherein the pixel value of each pixel of the at least one first set of pixels is greater than the pixel value threshold. At sub-step 504D, the method 500 comprises determining the at least one first set of pixels as the at least one pixel blob within the bounding box. In an embodiment, to associate the at least one pixel blob with one of the character or the defect within each bounding box, the method 500 comprises sub-steps 506A-506D for each bounding box, as depicted in FIG. 5C.

At sub-step 506A, the method 500 comprises determining a size of the at least one blob based on a number of the at least one first set of pixels associated with the at least one blob. At sub-step 506B, the method 500 comprises determining whether the size of the at least one blob is within a first threshold range. At sub-step 506C, the method 500 comprises upon determining that the size of the at least one blob is within the first threshold range, associating the at least blob with the character within the bounding box. At sub-step 506D, the method 500 comprises upon determining that the size of the blob is not within the first threshold range, associating the at least one blob with the defect within the bounding box.

In an embodiment, prior to extracting the one or more features in step 510, the method 500 comprises steps 509A-509G, as depicted in FIGS. 5D-5E.

At step 509A, the method 500 comprises identifying, within the processed image, one or more additional pixel blobs based on one or more second set of pixels within the processed image. Each pixel of the one or more second set of pixels has a corresponding pixel value greater than the pixel value threshold.

At step 509B, the method 500 comprises determining a corresponding size of the one or more additional pixel blobs within the processed image.

At step 509C, the method 500 comprises determining whether the corresponding size of the one or more additional pixel blobs is within a second threshold range.

At step 509D, the method 500 comprises upon determining that the corresponding size of the one or more additional pixel blobs is within the second threshold range, associating the one or more additional pixel blobs with a corresponding remaining character within the processed image;

At step 509E, the method 500 comprises upon determining that the corresponding size of the one or more additional pixel blobs is not within the second threshold range, associating the one or more additional pixel blobs with a corresponding remaining defect within the processed image.

At step 509F, the method 500 comprises when the one or more additional pixel blobs are associated with the corresponding remaining character within the processed image, removing, from the processed image, the corresponding remaining character to form a respective space within the processed image, and filling the respective space within the processed image with the mean pixel value.

At step 509G, the method 500 comprises when the one or more additional pixel blobs are associated with a corresponding remaining defect, retaining the corresponding defect within the processed image.

In an embodiment, the first threshold range comprises a first lower threshold and a first upper threshold and the second threshold range comprises a second lower threshold and a second upper threshold. In an embodiment, the first upper threshold is greater than the second upper threshold and the first lower threshold is lower than the second lower threshold.

While the above-discussed steps in FIGS. 4A-5E are shown and described in a particular sequence, the steps may occur in variations to the sequence in accordance with various embodiments. Further, a detailed description related to the various steps of FIGS. 4A-5E is already covered in the description related to FIGS. 1-3 and is omitted herein for the sake of brevity.

The present disclosure provides the technical advantages of eliminating the need for a model to learn every type of character combination. A visual inspection process is provided with high accuracy and reliability. The process of visual inspection is not slow and tedious. With the text removal process being performed for each bounding box, the characters are removed one by one based on blob-size thresholding. Accordingly, only the characters are removed while the defects are retained. The defect within text areas and overlapping with characters can also be identified based on the blob-size thresholding.

Further, with the use of compact bounding boxes for each character, any defect relatively far from the character is not removed. Isolating the character also makes the text removal process, such as comparison with blob threshold ranges, more robust. Moreover, any defect overlapping or in the vicinity of the character is also not removed. A repeat of the text removal process assures that any remaining characters, such as deformed characters or uniquely shaped characters, are not missed.

When a defect is present near the character, the defect may be disconnected from the character. The defect in itself may not fall within the threshold range and will be retained. Alternatively, presence of multiple blobs within a bounding box may be an indication of a defect within the bounding box. Further, when a defect is overlapping with the character, a total size of the corresponding blob may increase significantly, thereby not falling within the threshold range and being retained as a defect. In an exemplary scenario, the size of the corresponding blob may increase when the defect is of same color pixels as the character. In an alternate scenario, the overlapping defect may be of different color pixels as compared to the character, and thus, will separate the character into different blobs of connected same value pixels, wherein each of the different blobs will not fall within the threshold range and will be retained as defect.

With the filling of the removed characters with mean pixel value, the image is stabilized for feature extraction, such as HOG feature extraction, without introducing noise for the feature extraction. With HOG feature extraction, the retained defects will show high intensity. Further, alignment and cropping of the image received from the imaging device facilitates easier defect detection from the image. Additionally, the alignment and cropping enables proper processing of image since a consistent image is received every time in view of the alignment and cropping. As a result, the subsequent process after the alignment and cropping of image is consistent, extra computational effort in removing text is eliminated, and training of the AI model training is easier.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A method for visual inspection of a target product, the method comprising:
receiving an image associated with the target product;
generating a plurality of region of interests (ROIs) associated with the image, wherein the plurality of ROIs comprises a plurality of terminal ROIs and a plurality of non-terminal ROIs;
identifying, based on the plurality of non-terminal ROIs, a first set of features and a second set of features associated with the image, wherein the first set of features and the second set of features are indicative of one of a presence of defect within the image or an absence of defect within the image; and
determining, based on the first set of features and the second set of features, a result of the visual inspection of the target product associated with the image, wherein the result is one of a success result or a failure result.

2. The method of claim 1, wherein determining the result of the visual inspection of the target product associated with the image comprises:
providing the first set of features and the second set of features as an input to an artificial intelligence (AI) model;
receiving, from the AI model, a prediction value indicative of one of a probability of presence of defect within the image or a probability of absence of defect within the image;
comparing the prediction value with a predetermined threshold; and
determining the result of the visual inspection to be one of the success result or the failure result based on the comparison.

3. The method of claim 1, wherein generating the plurality of ROIs comprises:
determining an orientation associated with the received image based on an edge filtering technique;
determining at least one image corner and at least one terminal corner associated with the received image based on the edge filtering technique;
generating a cropped image based on determined orientation, the determined at least one image corner and the determined at least one terminal corner; and
generating the plurality of ROIs based on the cropped image.

4. The method of claim 3, wherein prior to identifying the first set of features and the second set of features, the method comprises:
determining, based on the at least one terminal corner, whether a terminal of the target product is associated with a defective length;
upon determining that the terminal of the target product is not associated with the defective length, identifying the first set of features and the second set of features associated with the image; and
upon determining that the terminal of the target product is associated with the defective length, determining the result of the visual inspection to be a failure result.

5. The method of claim 1, wherein identifying the first set of features comprises:
extracting, from each non-terminal ROI of the plurality of non-terminal ROIs, one or more statistical features;
generating the first set of features based on the extracted one or more statistical features from each non-terminal ROI of the plurality of non-terminal ROIs.

6. The method of claim 1, wherein identifying the second set of features comprises:
generating one or more bounding boxes within the image;
for each bounding box of the one or more bounding boxes:
identifying at least one pixel blob based on a plurality of pixels within the bounding box;
associating the at least one pixel blob with one of a character within the bounding box or a defect within the bounding box;
generating a processed image based on the association of the at least one pixel blob of each bounding box of the one or more bounding boxes; and
extracting the second set of features from the processed image based on a Histogram of Gradient (HOG) extracting technique.

7. The method of claim 6, wherein generating the one or more bounding boxes comprise:
determining a first ROI from among the plurality of ROIs within the image, the first ROI being indicative of an area of the image comprising one or more characters;
detecting the one or more characters within the first ROI based on a character detection technique; and
for each detected character of the one or more characters, generating a bounding box associated with the corresponding character, thereby generating the one or more bounding boxes.

8. The method of claim 6, wherein identifying the at least one pixel blob comprises:
for each bounding box:
determining a pixel value associated with each pixel of the plurality of pixels within the bounding box;
comparing, with a pixel value threshold, the pixel value associated with each pixel;
identifying at least one first set of pixels from among the plurality of pixels based on the comparison, wherein the pixel value of each pixel of the at least one first set of pixels is greater than the pixel value threshold; and
determining the at least one first set of pixels as the at least one pixel blob within the bounding box.

9. The method of claim 8, wherein associating the at least one pixel blob with one of the character or the defect comprises:
for each bounding box:
determining a size of the at least one blob based on a number of the at least one first set of pixels associated with the at least one blob;
determining whether the size of the at least one blob is within a first threshold range;
upon determining that the size of the at least one blob is within the first threshold range, associating the at least blob with the character within the bounding box; and
upon determining that the size of the blob is not within the first threshold range, associating the at least one blob with the defect within the bounding box.

10. The method of claim 6, wherein generating the processed image comprises:
for each bounding box, when the at least one blob is associated with the character within the bounding box:
removing, from the image, the character to form a respective space within the image;
determining a mean pixel value associated with the image; and
filling the respective space within the image with one or more new pixels having the mean pixel value.

11. The method of claim 10, further comprising:
for each bounding box:
when the at least one blob is associated with the defect within the bounding box, retaining the defect within the image.

12. The method of claim 9, further comprising, prior to extracting the second set of features:
identifying, within the processed image, one or more additional pixel blobs based on one or more second set of pixels within the processed image; wherein each pixel of the one or more second set of pixels has a corresponding pixel value greater than the pixel value threshold;
determining a corresponding size of the one or more additional pixel blobs within the processed image;
determining whether the corresponding size of the one or more additional pixel blobs is within a second threshold range;
upon determining that the corresponding size of the one or more additional pixel blobs is within the second threshold range, associating the one or more additional pixel blobs with a corresponding remaining character within the processed image; and
upon determining that the corresponding size of the one or more additional pixel blobs is not within the second threshold range, associating the one or more additional pixel blobs with a corresponding remaining defect within the processed image.

13. The method of claim 12, further comprising:
when the one or more additional pixel blobs are associated with the corresponding remaining character within the processed image:
removing, from the processed image, the corresponding remaining character to form a respective space within the processed image; and
filling the respective space within the processed image with the mean pixel value; and
when the one or more additional pixel blobs are associated with a corresponding remaining defect, retaining the corresponding defect within the processed image.

14. The method of claim 12, wherein:
the first threshold range comprises a first lower threshold and a first upper threshold,
the second threshold range comprises a second lower threshold and a second upper threshold,
the first upper threshold is greater than the second upper threshold, and
the first lower threshold is lower than the second lower threshold.

15. The method of claim 1, further comprising one or more of:
storing the result of the visual inspection of the target product in a database; and
displaying the result of the visual inspection of the target product on a user interface.

16. A method for extracting features from an image associated with a target product, the method comprising:
receiving the image associated with the target product;
identifying at least one pixel blob within the image;
associating the at least one pixel blob with one of a character or a defect;
generating a processed image based on said association, wherein generating the processed image comprises:
when the at least one blob is associated with the character:
removing, from the image, the character to form a respective space within the image;
determining a mean pixel value associated with the image; and
filling the respective space within the image with one or more new pixels having the mean pixel value;
when the at least one blob is associated with the defect, retaining the defect within the image; and
extracting one or more features from the processed image based on a Histogram of Gradient (HOG) extracting technique.

17. The method of claim 16, comprising:
determining a ROI within the image, the ROI being indicative of an area of the image comprising one or more characters;
detecting the one or more characters within the ROI based on a character detection technique;
generating one or more bounding boxes by generating a bounding box associated with a corresponding character of the one or more characters,
wherein identifying at least one pixel blob within the image comprises identifying, for each bounding box, the at least one pixel blob, and
wherein associating the at least one pixel blob with one of a character or a defect comprises associating, for each bounding box, the at least one pixel blob with one of the character or the defect within the bounding box.

18. The method of claim 17, wherein identifying the at least one pixel blob comprises:
for each bounding box:
determining a pixel value associated with each pixel of the plurality of pixels within the bounding box;
comparing, with a pixel value threshold, the pixel value associated with each pixel;
identifying at least one first set of pixels from among the plurality of pixels based on the comparison, wherein the pixel value of each pixel of the at least one first set of pixels is greater than the pixel value threshold; and
determining the at least one first set of pixels as the at least one pixel blob within the bounding box.

19. The method of claim 18, wherein associating the at least one pixel blob with one of the character or the defect comprises:
for each bounding box:
determining a size of the at least one blob based on a number of the at least one first set of pixels associated with the at least one blob;
determining whether the size of the at least one blob is within a first threshold range;
upon determining that the size of the at least one blob is within the first threshold range, associating the at least blob with the character within the bounding box; and
upon determining that the size of the blob is not within the first threshold range, associating the at least one blob with the defect within the bounding box.

20. The method of claim 16, further comprising, prior to extracting the one or more features:
identifying, within the processed image, one or more additional pixel blobs based on one or more second set of pixels within the processed image; wherein each pixel of the one or more second set of pixels has a corresponding pixel value greater than the pixel value threshold;
determining a corresponding size of the one or more additional pixel blobs within the processed image;
determining whether the corresponding size of the one or more additional pixel blobs is within a second threshold range;
upon determining that the corresponding size of the one or more additional pixel blobs is within the second threshold range, associating the one or more additional pixel blobs with a corresponding remaining character within the processed image;
upon determining that the corresponding size of the one or more additional pixel blobs is not within the second threshold range, associating the one or more additional pixel blobs with a corresponding remaining defect within the processed image;
when the one or more additional pixel blobs are associated with the corresponding remaining character within the processed image:
removing, from the processed image, the corresponding remaining character to form a respective space within the processed image; and
filling the respective space within the processed image with the mean pixel value; and
when the one or more additional pixel blobs are associated with a corresponding remaining defect, retaining the corresponding defect within the processed image.

21. The method of claim 20, wherein:
the first threshold range comprises a first lower threshold and a first upper threshold,
the second threshold range comprises a second lower threshold and a second upper threshold,
the first upper threshold is greater than the second upper threshold, and
the first lower threshold is lower than the second lower threshold.

22. A system for visual inspection of a target product, the system comprising:
a memory; and
at least one processor communicably coupled with the memory, the at least one processor being configured to:
receive an image associated with the target product;
generate a plurality of region of interests (ROIs) associated with the image, wherein the plurality of ROIs comprises a plurality of terminal ROIs and a plurality of non-terminal ROIs;
identify, based on the plurality of non-terminal ROIs, a first set of features and a second set of features associated with the image, wherein the first set of features and the second set of features are indicative of one of a presence of defect within the image or an absence of defect within the image; and
determine, based on the first set of features and the second set of features, a result of the visual inspection of the target product associated with the image, wherein the result is one of a success result or a failure result.

23. The system of claim 22, wherein to determine the result of the visual inspection of the target product associated with the image, the at least one processor is configured to:
provide the first set of features and the second set of features as an input to an artificial intelligence (AI) model;
receive, from the AI model, a prediction value indicative of one of a probability of presence of defect within the image or a probability of absence of defect within the image;
compare the prediction value with a predetermined threshold; and
determine the result of the visual inspection to be one of the success result or the failure result based on the comparison.

24. The system of claim 22, wherein to generate the plurality of ROIs, the at least one processor is configured to:
determine an orientation associated with the received image based on an edge filtering technique;
determine at least one image corner and at least one terminal corner associated with the received image based on the edge filtering technique;
generate a cropped image based on determined orientation, the determined at least one image corner and the determined at least one terminal corner; and
generate the plurality of ROIs based on the cropped image.

25. The system of claim 24, wherein prior to identifying the first set of features and the second set of features, the at least one processor is configured to:
determine, based on the at least one terminal corner, whether a terminal of the target product is associated with a defective length;
upon a determination that the terminal of the target product is not associated with the defective length, identify the first set of features and the second set of features associated with the image; and
upon a determination that the terminal of the target product is associated with the defective length, determine the result of the visual inspection to be a failure result.

26. The system of claim 22, wherein to identify the first set of features, the at least one processor is configured to:
extract, from each non-terminal ROI of the plurality of non-terminal ROIs, one or more statistical features;
generate the first set of features based on the extracted one or more statistical features from each non-terminal ROI of the plurality of non-terminal ROIs.

27. The system of claim 22, wherein to identify the second set of feature, the at least one processor is configured to:
generate one or more bounding boxes within the image;
for each bounding box of the one or more bounding boxes:
identify at least one pixel blob based on a plurality of pixels within the bounding box;
associate the at least one pixel blob with one of a character within the bounding box or a defect within the bounding box;
generate a processed image based on the association of the at least one pixel blob of each bounding box of the one or more bounding boxes; and
extract the second set of features from the processed image based on a Histogram of Gradient (HOG) extracting technique.

28. The system of claim 27, wherein to generate the one or more bounding boxes, the at least one processor is configured to:
determine a first ROI from among the plurality of ROIs within the image, the first ROI being indicative of an area of the image comprising one or more characters;
detect the one or more characters within the first ROI based on a character detection technique; and
for each detected character of the one or more characters, generate a bounding box associated with the corresponding character, thereby generating the one or more bounding boxes.

29. The system of claim 27, wherein to identify the at least one pixel blob, the at least one processor is configured to:
for each bounding box:
determine a pixel value associated with each pixel of the plurality of pixels within the bounding box;
compare, with a pixel value threshold, the pixel value associated with each pixel;
identify at least one first set of pixels from among the plurality of pixels based on the comparison, wherein the pixel value of each pixel of the at least one first set of pixels is greater than the pixel value threshold; and
determine the at least one first set of pixels as the at least one pixel blob within the bounding box.

30. The system of claim 29, wherein to associate the at least one pixel blob with one of the character or the defect, the at least one processor is configured to:
for each bounding box:
determine a size of the at least one blob based on a number of the at least one first set of pixels associated with the at least one blob;
determine whether the size of the at least one blob is within a first threshold range;
upon a determination that the size of the at least one blob is within the first threshold range, associate the at least blob with the character within the bounding box; and
upon a determination that the size of the blob is not within the first threshold range, associate the at least one blob with the defect within the bounding box.

31. The system of claim 27, wherein to generate the processed image, the at least one processor is configured to:
for each bounding box, when the at least one blob is associated with the character within the bounding box:
remove, from the image, the character to form a respective space within the image;
determine a mean pixel value associated with the image; and
fill the respective space within the image with one or more new pixels having the mean pixel value.

32. The system of claim 31, wherein the at least one processor is further configured to:
for each bounding box:
when the at least one blob is associated with the defect within the bounding box, retain the defect within the image.

33. The system of claim 30, wherein the at least one processor is further configured to, prior to extracting the second set of features:
identify, within the processed image, one or more additional pixel blobs based on one or more second set of pixels within the processed image; wherein each pixel of the one or more second set of pixels has a corresponding pixel value greater than the pixel value threshold;
determine a corresponding size of the one or more additional pixel blobs within the processed image;
determine whether the corresponding size of the one or more additional pixel blobs is within a second threshold range;
upon a determination that the corresponding size of the one or more additional pixel blobs is within the second threshold range, associate the one or more additional pixel blobs with a corresponding remaining character within the processed image; and
upon a determination that the corresponding size of the one or more additional pixel blobs is not within the second threshold range, associate the one or more additional pixel blobs with a corresponding remaining defect within the processed image.

34. The system of claim 33, wherein the at least one processor is further configured to:
when the one or more additional pixel blobs are associated with the corresponding remaining character within the processed image:
remove, from the processed image, the corresponding remaining character to form a respective space within the processed image; and
fill the respective space within the processed image with the mean pixel value; and
when the one or more additional pixel blobs are associated with a corresponding remaining defect, retain the corresponding defect within the processed image.

35. The system of claim 33, wherein:
the first threshold range comprises a first lower threshold and a first upper threshold,
the second threshold range comprises a second lower threshold and a second upper threshold,
the first upper threshold is greater than the second upper threshold, and
the first lower threshold is lower than the second lower threshold.

36. The system as claimed in claim 22, wherein the at least one processor is configured to perform one or more of:
store the result of the visual inspection of the target product in a database; and
display the result of the visual inspection of the target product on a user interface.

37. A system to extract features from an image associated with a target product, the system comprising:
a memory; and
at least one processor communicably coupled with the memory, the at least one processor being configured to:
receive the image associated with the target product;
identify at least one pixel blob within the image;
associate the at least one pixel blob with one of a character or a defect;
generate a processed image based on said association, wherein to generate the processed image, the at least one processor is configured to:
when the at least one blob is associated with the character:
remove, from the image, the character to form a respective space within the image;
determine a mean pixel value associated with the image; and
fill the respective space within the image with one or more new pixels having the mean pixel value;
when the at least one blob is associated with the defect, retain the defect within the image; and
extract one or more features from the processed image based on a Histogram of Gradient (HOG) extracting technique.

38. The system of claim 37, wherein the at least one processor is further configured to:
determine a ROI within the image, the ROI being indicative of an area of the image comprising one or more characters;
detect the one or more characters within the ROI based on a character detection technique;
generate one or more bounding boxes by generating a bounding box associated with a corresponding character of the one or more characters,
wherein to identify at least one pixel blob within the image, the at least one processor is configured to identify, for each bounding box, the at least one pixel blob, and
wherein to associate the at least one pixel blob with one of a character or a defect, the at least one processor is configured to associate, for each bounding box, the at least one pixel blob with one of the character or the defect within the bounding box.

39. The system of claim 38, wherein to identify the at least one pixel blob, the at least one processor is configured to:
for each bounding box:
determine a pixel value associated with each pixel of the plurality of pixels within the bounding box;
compare, with a pixel value threshold, the pixel value associated with each pixel;
identify at least one first set of pixels from among the plurality of pixels based on the comparison, wherein the pixel value of each pixel of the at least one first set of pixels is greater than the pixel value threshold; and
determine the at least one first set of pixels as the at least one pixel blob within the bounding box.

40. The system of claim 39, wherein to associate the at least one pixel blob with one of the character or the defect, the at least one processor is configured to:
for each bounding box:
determine a size of the at least one blob based on a number of the at least one first set of pixels associated with the at least one blob;
determine whether the size of the at least one blob is within a first threshold range;
upon a determination that the size of the at least one blob is within the first threshold range, associate the at least blob with the character within the bounding box; and
upon a determination that the size of the blob is not within the first threshold range, associate the at least one blob with the defect within the bounding box.

41. The system of claim 37, wherein, prior to extracting the one or more features, the at least one processor is further configured to:
identify, within the processed image, one or more additional pixel blobs based on one or more second set of pixels within the processed image; wherein each pixel of the one or more second set of pixels has a corresponding pixel value greater than the pixel value threshold;
determine a corresponding size of the one or more additional pixel blobs within the processed image;
determine whether the corresponding size of the one or more additional pixel blobs is within a second threshold range;
upon a determination that the corresponding size of the one or more additional pixel blobs is within the second threshold range, associate the one or more additional pixel blobs with a corresponding remaining character within the processed image;
upon a determination that the corresponding size of the one or more additional pixel blobs is not within the second threshold range, associate the one or more additional pixel blobs with a corresponding remaining defect within the processed image;
when the one or more additional pixel blobs are associated with the corresponding remaining character within the processed image:
remove, from the processed image, the corresponding remaining character to form a respective space within the processed image; and
fill the respective space within the processed image with the mean pixel value; and
when the one or more additional pixel blobs are associated with a corresponding remaining defect, retain the corresponding defect within the processed image.

42. The system of claim 41, wherein:
the first threshold range comprises a first lower threshold and a first upper threshold,
the second threshold range comprises a second lower threshold and a second upper threshold,
the first upper threshold is greater than the second upper threshold, and
the first lower threshold is lower than the second lower threshold.
